(19) United States
(12) Patent Application Publication
(10) Pub. No.: US 2009/0015006 A1
(43) Pub. Date: Jan. 15, 2009

(54) Flexible entry boot apparatus

(76) Inventors: Eric Miner, Santa Rosa, CA (US); Frank Lillo, Santa Rosa, CA (US)

Correspondence Address: LARRY D. JOHNSON, P.O. BOX 470277, CELEBRATION, FL, 34747, US

(21) Appl. No.: 12/156,393

(22) Filed: May 30, 2008

Related U.S. Application Data
(60) Provisional application No. 60/932,266, filed on May 30, 2007.

(51) Int. Cl. F16L 5/02; F16L 5/10; F16L 41/06

(52) U.S. Cl. 285/141.1; 285/201

(57) ABSTRACT

A fluid-tight fitting between a wall of a fluid containment region or sump, and a conduit or pipe passing through a wall of the sump includes a two part double booted flexible entry boot system which is bonded directly to the interior and exterior sump walls, thus making the inventive boot an actual extension of the sump. The boots are placed within the sump area and are easily accessible. The apparatus provides a continuation of the secondary or annular space of the sump (where so configured) into the penetration device boots.

### CROSS REFERENCE TO RELATED APPLICATIONS

The present application claims the benefit of the filing date of U.S. Provisional Patent Application Ser. No. 60/932,266, filed May 30, 2007.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to fluid containment methods and apparatus, and more particularly to an improved flexible entry boot apparatus.

### BACKGROUND INFORMATION AND DISCUSSION OF RELATED ART

Traditional penetrations for fluid containment regions locate their boots and seals on the outside of the sump wall. After installation and burial, these boots are “lost” from sight, are unprotected and cannot be inspected or adjusted if needed. Furthermore, previous penetration devices were “stand alone” and did not provide a means whereby an alarm or warning system could be incorporated into their components. This left the penetration device without any protection or the operator any means by which to insure the integrity of the penetrations. A hole was simply cut into the sump in the field and the penetration was attached, typically drilled and nut and bolted to the sump body, and mistakes were quite common.

For example, U.S. Pat. No. 6,145,891 to Youngs discloses a double booted flexible entry boot which provides a fluid-tight fitting between a wall of a fluid containment region and a conduit passing through the wall. An inner seal member is disposed within the containment region, the inner seal member having a substantially planar seal portion and an integral first hollow support sleeve concentric with the seal portion and extending axially into the containment region. A mechanism is provided for rigidifying the seal portion of the inner seal member. A mechanism releasably attaches the first hollow support sleeve to the conduit. An outer seal member is disposed outside of the containment region, the outer seal member having a substantially planar seal portion and an integral second hollow support sleeve concentric with the seal portion and extending axially away from the containment region. A mechanism is provided for rigidifying the seal portion of the outer seal member. The first and second support sleeves have a degree of flexibility sufficient to allow for the insertion of the conduit at angles not necessarily normal to the fluid containment wall. A mechanism releasably attaches the second hollow support sleeve to the conduit. A mechanism, carried by the rigidified seal portion of the outer seal member and adapted to extend axially through the wall and the rigidified seal portion of the inner seal member, releasably attaches the inner seal member to the wall of the containment region. The inner seal member may be repaired or replaced without substantial outside fluid invading the containment region.

U.S. Pat. No. 7,051,580 to Lewis, et al. describes a hydraulic monitoring method and apparatus which provides a monitoring system which replaces the void or air space within the interstitial/annular volume of double wall piping with an inert environmentally safe, food grade, hydraulic liquid. Monitoring of the liquid provides rapid, real time sensing of any alarm phase or mode. The method identifies primary piping failures or any secondary containment piping breech or wall penetration with an immediate level change within the fluid sensor monitor reservoirs. If the fluid level decreases, a breech in the secondary containment piping is evidenced. If the fluid level increases, a primary piping wall failure is indicated. This level change can be electronically monitored for rapid system alert and/or system/pump shutdown. The foregoing patents reflect the current state of the art of which the present inventors are aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The flexible entry boot apparatus of the present invention provides a fluid-tight fitting between a wall of a fluid containment region or sump, and a conduit or pipe passing through a wall of the sump. The inventive apparatus provides a two part double booted flexible entry boot system which is bonded directly to the interior and exterior sump walls, thus making the inventive boot an actual extension or part of the sump. The inventive boot also provides a continuation of the secondary or annular space of the sump (where so configured) into the penetration device boots, which can be of added benefit due to the fact that the interstitial or annular space of a sump is typically monitored. The inventive boots are placed within the sump area and are easily accessible, unlike traditional penetrations that locate their boots and seals on the outside of the sump wall. The inventive boots can be factory installed and sumps using the inventive boots can come fully assembled, pre-tested and ready for pipe insertion. The inventive boot system is suitable for use with fiberglass reinforced plastic (FRP) or “hard” pipe as well as with “flex” pipe systems.

Benefits of the inventive boot system include, but are not limited to, the following:

The boots install inside the sump area for accessibility. The inventive boots can be factory installed and pre-tested to insure integrity. It may not be necessary to do anything in the field other than slip the piping through the fitting and tighten the clamps.

The inventive boot is open to and incorporates itself as part of the interstitial or annular area of the sump (where so equipped). This area can be electronically or hydrostatically monitored and will now include the penetration boots and fitting into this monitoring “loop”. Current penetration boot systems do not provide for monitoring of any type.

The inventive boot will work equally well with any piping system or type.

It is therefore an object of the present invention to provide a new and improved flexible entry boot.

It is another object of the present invention to provide a new and improved entry boot which is an actual extension or part of the sump.

A further object or feature of the present invention is a new and improved entry boot which can be electronically or hydrostatically monitored.

An even further object of the present invention is to provide a novel entry boot which works equally well with FRP or “hard” pipe as it does with “flex” systems.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified. There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention. Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a partially cutaway top plan view in of a flexible entry boot apparatus of this invention.

### DETAILED DESCRIPTION OF THE INVENTION

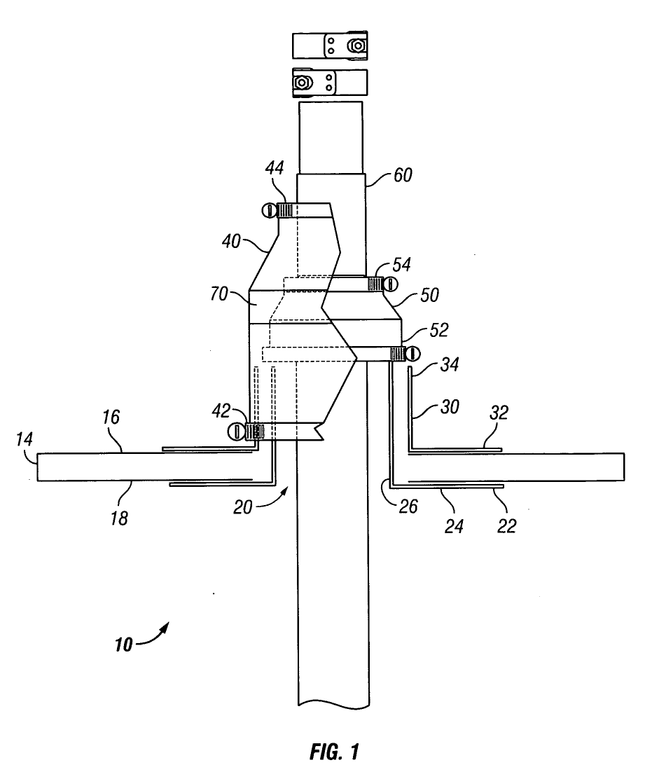

Referring to FIG. 1 there is illustrated therein a new and improved flexible entry boot apparatus, generally denominated 10 herein. Entry boot apparatus 10 may be used for installation into a sump 12 having a wall 14 with an inside surface 16 and an outside surface 18, and a pipe passage section or penetration aperture 20 through the wall. Entry boot apparatus 10 may include a first flange member 22 having a base portion 24 bonded to the sump wall outside surface 18, and a tubular portion 26 extending through the aperture 20 and into the internal cavity of the sump 12. A second flange member 30 has a base portion 32 bonded to the sump wall inside surface 16, and a tubular portion 34 extending into the internal cavity of the sump 12. The second flange member tubular portion 34 is preferably radially outward from and generally coaxial with the first flange member tubular portion 26, and may extend a short distance (e.g. one inch) further into the sump than the first flange member tubular portion 34.

An outside boot member 40 has a first end 42 and a second end 44. The first end 42 is band clamped or otherwise sealed to the second flange member tubular portion 34. An inside boot member 50 similarly has a first end 52 and a second end 54, the first end 52 being band clamped or otherwise sealed to the first flange member tubular portion 26 (clamping is facilitated by first flange member tubular portion 26 extending a short distance further into the sump than the first flange member tubular portion 34. A conduit or pipe 60 can be inserted through the aperture 20, and the inside boot second end 54 and the outside boot second end 44 can be band clamped or otherwise sealed to the pipe 60 to provide a double booted flexible entry for the pipe 60 into the sump 12. Inside boot second end 54 and outside boot second end 44 can be band clamped to the pipe 60 independently and spaced apart, as illustrated, or simultaneously with a single clamp capturing both second ends at one location.

The annular space 70 between the outside boot 40 and inside boot 50 provides a continuation of the of the interstitial or annular area of the sump (where so configured), i.e., a void between the sump wall inside surface 16 and outside surface 18. This area can be electronically or hydrostatically monitored and will now include the penetration boots and fitting into this monitoring “loop”.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A flexible entry boot apparatus comprising:
a sump having a wall with an inside surface and an outside surface, and an aperture through said wall;
a first flange member having a base portion bonded to said sump wall outside surface and a tubular portion extending through said aperture and into said sump;
a second flange member having a base portion bonded to said sump wall inside surface and a tubular portion extending into said sump;
an outside boot member having a first end and a second end, said first end sealed to said second flange member tubular portion; and
an inside boot member having a first end and a second end, said first end sealed to said first flange member tubular portion, wherein a pipe can be inserted through said aperture, and said inside boot second end and said outside boot second end sealed to the pipe to provide a double booted flexible entry for the pipe into said sump.

2. The flexible entry boot apparatus of claim 1 wherein said second flange member tubular portion is radially outward from said first flange member tubular portion.

3. The flexible entry boot apparatus of claim 1 wherein said second flange member tubular portion is generally coaxial with said first flange member tubular portion.

4. The flexible entry boot apparatus of claim 1 wherein said outside boot member and said inside boot member define an annular space contiguous with said sump wall.

5. The flexible entry boot apparatus of claim 1 wherein said second flange member tubular portion extends further into said sump than said first flange member tubular portion.
